(19) United States
(12) Patent Application Publication
(10) Pub. No.: US 2026/0194639 A1
(43) Pub. Date: Jul. 9, 2026

(54) COMPACT INTEGRATED LIGHT DETECTION AND RANGING (LIDAR) SYSTEM

(71) Applicant: AEVA, INC., Mountain View, CA (US)

(72) Inventors: Behsan Behzadi, Sunnyvale, CA (US); Mina Rezk, Haymarket, VA (US)

(21) Appl. No.: 19/009,339

(22) Filed: Jan. 3, 2025

(51) Int. Cl. G01S 7/4912; G01S 7/481; G01S 7/499; G01S 17/34; G01S 17/58

(52) U.S. Cl. CPC G01S 7/4917; G01S 7/4811; G01S 7/4815; G01S 7/4817; G01S 7/499; G01S 17/34; G01S 17/58

(57) ABSTRACT

A light detection and ranging (LIDAR) system with a sensing system that emits a plurality of outgoing optical beams is disclosed. The sensing system includes a plurality of optical sources to emit a plurality of optical signals, which are combined to form combined optical signals. The sensing system also includes a transmit/receive (TX/RX) subsystem to receive the combined optical signals and distribute each combined optical signal between a plurality of TX/RX units as separate input signals. Each TX/RX unit is configured to emit a respective one of the separate input signals to generate one of the plurality of outgoing optical beams, receive light returned from a target as a return optical beam, and generate a beat frequencies from the return optical beam. The sensing system also includes a signal processing system to determine a target range and velocity from the beat frequencies generated by each of the TX/RX units.

### FIELD OF INVENTION

The present disclosure is related to light detection and ranging (LIDAR) systems, and more particularly to a highly integrated photonics-based device for coherent LIDAR systems.

### BACKGROUND

Frequency-Modulated Continuous-Wave (FMCW) LIDAR systems use tunable lasers for frequency-chirped illumination of targets, and coherent receivers for detection of backscattered or reflected light from the targets that are combined with a local copy of the transmitted signal. Mixing the local copy with the return signal, delayed by the round-trip time to the target and back, generates a beat frequency at the receiver that is proportional to the distance to each target in the field of view of the system.

These types of LIDAR systems are sometimes used on autonomous vehicles for navigation purposes. To obtain a real-time view of the surrounding environment, the LIDAR system scans the environment with an optical beam generated by a rangefinder and generates a point cloud, wherein each point in the point cloud represents a detected location of an object and the object's speed. The LIDAR systems usually scan the environment along a vertical and horizontal axis using several different types of scanning mirrors. For example, the horizontal axis may be scanned using a rotating, multifaceted mirror, while the vertical axis may be scanned by a one-dimensional (1D) scanning mirror controlled by a galvanometer.

### BRIEF DESCRIPTION OF THE DRAWINGS

For a more complete understanding of the various examples, reference is now made to the following detailed description taken in connection with the accompanying drawings in which like identifiers correspond to like elements.

FIG. 1 is a block diagram of an example LIDAR system in accordance with some embodiments of the present disclosure.

FIG. 2 is a time-frequency diagram of FMCW scanning signals that can be used by a LIDAR system in accordance with some embodiments of the present disclosure.

FIG. 3 is a plan view of a sensing system for a FMCW LIDAR system in accordance with some embodiments of the present disclosure.

FIG. 4A depicts one example of the reference subsystem in accordance with some embodiments of the present disclosure.

FIG. 4B depicts another example of the reference subsystem in accordance with some embodiments of the present disclosure.

FIG. 4C depicts another example of the reference subsystem in accordance with some embodiments of the present disclosure.

FIG. 4D depicts another example of the reference subsystem in accordance with some embodiments of the present disclosure.

FIG. 4E depicts another example of the reference subsystem in accordance with some embodiments of the present disclosure.

FIG. 5A depicts one example of a sensing system in accordance with some embodiments of the present disclosure.

FIG. 5B depicts another example of a sensing system in accordance with some embodiments of the present disclosure.

FIG. 6A is an example embodiment of a TX/RX unit that can be included in the TX/RX subsystem in accordance with some embodiments of the present disclosure.

FIG. 6B is another example embodiment of a TX/RX unit that can be included in the TX/RX subsystem in accordance with some embodiments of the present disclosure.

FIG. 6C is another example embodiment of a TX/RX unit that can be included in the TX/RX subsystem in accordance with some embodiments of the present disclosure.

FIG. 7A illustrates an example optical signal routing configuration that may be used in the TX/RX subsystem in accordance with some embodiments of the present disclosure.

FIG. 7B illustrates another example optical signal routing configuration that may be used in the TX/RX subsystem in accordance with some embodiments of the present disclosure.

FIG. 8A is another example embodiment of a TX/RX unit that can be included in the TX/RX subsystem in accordance with some embodiments of the present disclosure.

FIG. 8B is an example embodiment of a TX/RX subsystem with a surface coupled output in accordance with some embodiments of the present disclosure.

FIG. 9 is another example of a sensing system in accordance with some embodiments of the present disclosure.

FIG. 10 is another example of a sensing system in accordance with some embodiments of the present disclosure.

FIG. 11 depicts another example of a sensing system in accordance with some embodiments of the present disclosure.

FIG. 12 is another example of a sensing system in accordance with some embodiments of the present disclosure.

FIG. 13 is a process flow diagram of a method of operating a LIDAR system in accordance with some embodiments of the present disclosure.

### DETAILED DESCRIPTION

The present disclosure describes various examples of LIDAR systems and methods for detecting distance and relative speed of objects. Various embodiments of the present disclosure include a highly integrated photonics-based device for coherent LIDAR systems. The LIDAR system described herein may be implemented in any sensing market, such as, but not limited to, transportation, manufacturing, metrology, medical, virtual reality, augmented reality, and security systems. According to some embodiments, the described LIDAR system is implemented as part of a front-end of frequency modulated continuous-wave (FMCW) device that assists with spatial awareness for automated driver assist systems, or self-driving vehicles.

In some LIDAR applications, it may be beneficial for the LIDAR system to generate point clouds that update quickly and have a large number of points, which increases the resolution of the point cloud and reduces latency. Since most LIDAR systems only generate a limited number of optical beams (e.g., 2 to 8), generating a large number of data points in a short time frame usually involves scanning the environment by sweeping the optical beams using mirrors with a high angular speed. However, high mirror angular speed may cause signal impairments that can reduce signal quality. For example, a mirror-induced Doppler shift may cause a broadening of the received signal bandwidth, which can reduce the measured intensity of the received signal. Additionally, the mirror movement during the round-trip time to and from a target can cause light returned from the target to be slightly off angle with respect to the scanning mirror when it arrives at the receiver. At higher mirror speeds, this lag angle can reduce the intensity of the received signal. The lag angle effect is sometimes referred to as descan. Doppler broadening and lag angle effects can reduce the signal-to-noise ratio (SNR) of received signals, which can reduce the probability of detection, increase false alarms, and increase error levels in the range and velocity estimations.

Additionally, the scanning components (e.g., mirrors, galvanometers, motors, mounts, etc.) tend to account for a large portion of the overall mechanical volume of many LIDAR systems. However, in applications such as automotive navigation, it is often desirable that the mechanical volume of the LIDAR system be as small as possible.

Embodiments of the present disclosure address these issues and others by providing an improved architecture for a LIDAR system. The LIDAR system disclosed herein includes a sensing system that combines several electronic and photonic components into a compact package that emits a large number of separate optical beams without the use of scanning mirrors. Increasing the number of optical beams that can be emitted by the sensing system enables the LIDAR system to increase the number of points measured for a given optical scanning arrangement. Accordingly, embodiments of the present techniques enable the scanning frequency and mirror speeds of a LIDAR system to be reduced while also increasing the number of point measurements collected. Reducing the mirror speed can mitigate the effects of doppler spreading and lag angle, thereby improving signal quality and probability of detection.

Embodiments of the present techniques also enable the implementation of a LIDAR system that is more compact and has fewer components. For example, the sensing system may emit several parallel optical beams stacked in a straight horizontal or vertical line. These output optical beams may be spread using a lens to fully cover one dimension of the LIDAR's field of view (FOV). In such embodiments, a three-dimensional FOV can be obtained by sweeping the several optical beams along a single axis, either vertical or horizontal rather than both. Accordingly, the LIDAR system can be implemented using fewer scanning components. In some embodiments, the sensing system may emit several parallel optical beams arranged in a 2D grid to cover both dimensions of the FOV. In such embodiments, the number of beams emitted by the sensing system may be sufficient to cover the desired FOV of the LIDAR system with a high point density, thereby eliminating the need to sweep the lasers using scanning mirrors. Eliminating the number of moving parts in a LIDAR system reduces the cost and the mechanical volume of the LIDAR system while also improving reliability by eliminating points of potential failure.

In the following description, reference may be made herein to quantitative measures, values, relationships or the like. Unless otherwise stated, any one or more if not all of these may be absolute or approximate to account for acceptable variations that may occur, such as those due to engineering tolerances or the like.

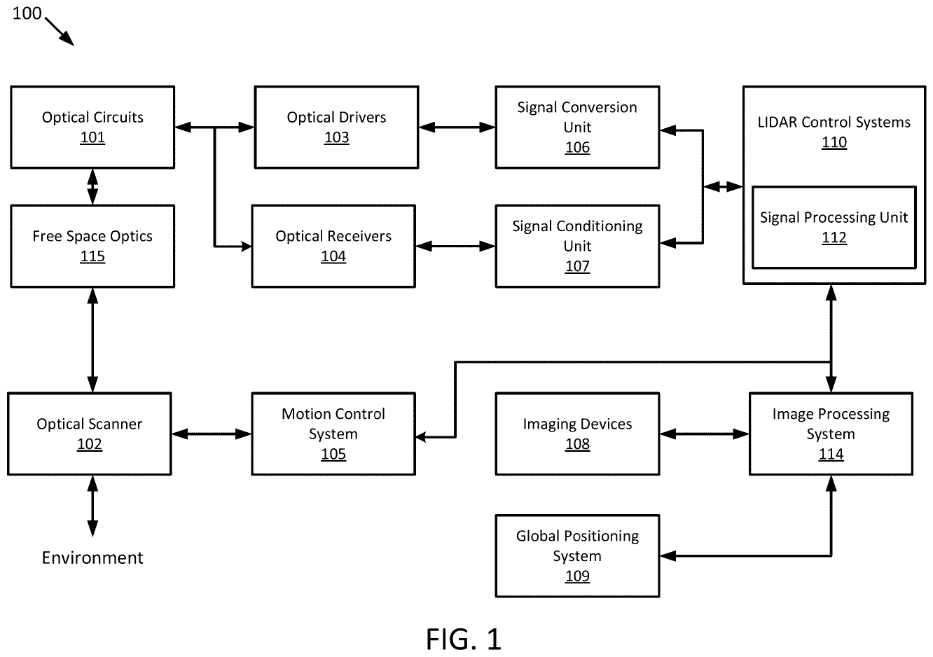

FIG. 1 is a block diagram of an example LIDAR system 100 in accordance with some embodiments of the present disclosure. The LIDAR system 100 includes one or more of each of a number of components but may include fewer or additional components than shown in FIG. 1. As shown, the LIDAR system 100 includes optical circuits 101 implemented on a photonics chip. The optical circuits 101 may include a combination of active optical components and passive optical components. Active optical components may generate, amplify, attenuate, and/or detect optical signals and the like. In some examples, the active optical component includes optical beams at different wavelengths, and includes one or more optical amplifiers, one or more optical detectors, or the like.

Free space optics 115 may include one or more optical waveguides to carry optical signals, and route and manipulate optical signals to appropriate input/output ports of the active optical circuit. The free space optics 115 may also include one or more optical components such as taps, wavelength division multiplexers (WDM), splitters/combiners, polarization beam splitters (PBS), collimators, polarization rotators (e.g., waveplate, faraday rotator), couplers or the like. In some examples, the free space optics 115 may include components to transform the polarization state and direct received polarized light to optical detectors using a PBS, for example. The free space optics 115 may further include a diffractive element to deflect optical beams having different frequencies at different angles along an axis (e.g., a fast-axis).

In some examples, the LIDAR system 100 includes an optical scanner 102 that includes one or more scanning mirrors that are rotatable along an axis (e.g., a slow-axis) that is orthogonal or substantially orthogonal to the fast-axis of the diffractive element to steer optical signals to scan an environment according to a scan pattern. For instance, the scanning mirrors may be rotatable by one or more galvanometers. Objects in the target environment may scatter an incident light into a return optical beam or a target return signal. The optical scanner 102 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 102 may include components such as a quarter-wave plate, lens, anti-reflective coated window or the like.

To control and support the optical circuits 101 and optical scanner 102, the LIDAR system 100 includes LIDAR control systems 110. The LIDAR control systems 110 may include a processing device for the LIDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LIDAR control systems 110 may include a signal processing unit 112 such as a DSP. The LIDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources.

The LIDAR control systems 110 are also configured to output digital control signals for the optical scanner 102. A motion control system 105 may control the galvanometers of the optical scanner 102 based on control signals received from the LIDAR control systems 110. For example, a digital-to-analog converter may convert coordinate routing information from the LIDAR control systems 110 to signals interpretable by the galvanometers in the optical scanner 102. In some examples, a motion control system 105 may also return information to the LIDAR control systems 110 about the position or operation of components of the optical scanner 102. For example, an analog-to-digital converter may in turn convert information about the galvanometers' position to a signal interpretable by the LIDAR control systems 110.

The LIDAR control systems 110 are further configured to analyze incoming digital signals. In this regard, the LIDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LIDAR control systems 110. Target receivers measure the optical signal that carries information about the range and velocity of a target in the form of a beat frequency, modulated optical signal. The reflected beam may be mixed with a second signal from a local oscillator. The optical receivers 104 may include a high-speed analog-to-digital converter to convert signals from the target receiver to signals interpretable by the LIDAR control systems 110. In some examples, the signals from the optical receivers 104 may be subject to signal conditioning by signal conditioning unit 107 prior to receipt by the LIDAR control systems 110. For example, the signals from the optical receivers 104 may be provided to an operational amplifier for amplification of the received signals and the amplified signals may be provided to the LIDAR control systems 110.

In some applications, the LIDAR system 100 may additionally include one or more imaging devices 108 configured to capture images of the environment, a global positioning system 109 configured to provide a geographic location of the system, or other sensor inputs. The LIDAR system 100 may also include an image processing system 114. The image processing system 114 can be configured to receive the images and geographic location, and send the images and location or information related thereto to the LIDAR control systems 110 or other systems connected to the LIDAR system 100.

In operation according to some examples, the LIDAR system 100 is configured to use nondegenerate optical sources to simultaneously measure range and velocity across two dimensions. This capability allows for real-time, long-range measurements of range, velocity, azimuth, and elevation of the surrounding environment.

In some examples, the scanning process begins with the optical drivers 103 and LIDAR control systems 110. The LIDAR control systems 110 instruct the optical drivers 103 to independently modulate one or more optical beams, and these modulated signals propagate through the passive optical circuit to the collimator. The collimator directs the light at the optical scanning system that scans the environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LIDAR system 100 may have natural reflective properties or a reflective coating to reflect a portion of the light back to the optical circuits 101.

Optical signals reflected from the environment pass through the optical circuits 101 to the receivers. Because the polarization of the light has been transformed, it may be reflected by a polarization beam splitter along with the portion of polarized light that was reflected back to the optical circuits 101. Accordingly, rather than returning to the same fiber or waveguide as an optical source, the reflected light is reflected to separate optical receivers. These signals interfere with one another and generate a combined signal. Each beam signal that returns from the target produces a time-shifted waveform. The temporal phase difference between the two waveforms in the combined signal generates a beat frequency measured on the optical receivers 104 (e.g., photodetectors).

The analog signals from the optical receivers 104 are converted to digital signals using ADCs. The digital signals are then sent to the LIDAR control systems 110. A signal processing unit 112 may then receive the digital signals and interpret them. In some embodiments, the signal processing unit 112 also receives position data from the motion control system 105 and galvanometers (not shown) as well as image data from the image processing system 114. The signal processing unit 112 can then generate a 3D point cloud with information about range and velocity of points in the environment as the optical scanner 102 scans additional points. The signal processing unit 112 can also overlay a 3D point cloud data with the image data to determine velocity and distance of objects in the surrounding area. The system also processes the satellite-based navigation location data to provide a precise global location.

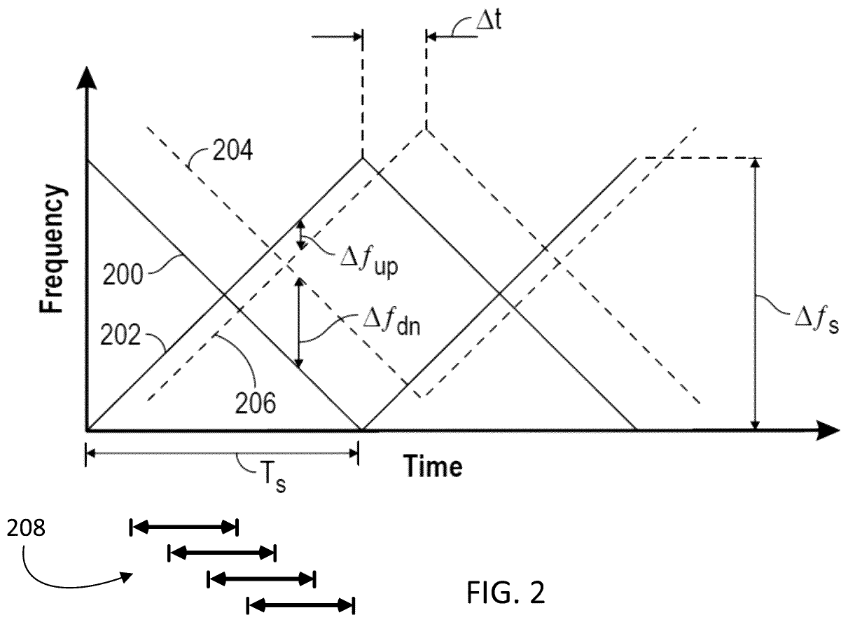

FIG. 2 is a time-frequency diagram of FMCW scanning signals that can be used by a LIDAR system in accordance with some embodiments of the present disclosure. The FMCW scanning signals 200 and 202 may be used in any suitable LIDAR system, including the system 100, to scan a target environment. The FMCW scanning signal 200 may be a triangular waveform with an up-chirp and a down-chirp having a same bandwidth Afs and period Ts. The other FMCW scanning signal 202 is also a triangular waveform that includes an up-chirp and a down-chirp with bandwidth Afs and period Ts. However, the two signals are inverted versions of one another such that the up-chirp on FMCW scanning signal 200 occurs in unison with the down-chirp on FMCW scanning signal 202.

FIG. 2 also depicts example return signals 204 and 206. The return signals 204 and 206, are time-delayed versions of the FMCW scanning signals 200 and 202, where Δt is the round trip time to and from a target illuminated by FMCW scanning signal 201. The round trip time is given as Δt=2R/v, where R is the target range and v is the velocity of the optical beam, which is the speed of light c. The target range, R, can therefore be calculated as R=c(Δt/2).

In embodiments, the time delay Δt is not measured directly, but is inferred based on the frequency differences between the transmitted scanning waveforms and the return signals. When the return signals 204 and 206 are optically mixed with the corresponding scanning signals, a signal referred to as a “beat frequency” is generated, which is caused by the combination of two waveforms of similar but slightly different frequencies. The beat frequency indicates the frequency difference between the transmitted scanning waveform and the return signal, which is linearly related to the time delay Δt by the slope of the triangular waveform.

If the return signal has been reflected from an object in motion, the frequency of the return signal will also be affected by the Doppler effect, which is shown in FIG. 2 as an upward shift of the return signals 204 and 206. Using an up-chirp and a down-chirp enables the generation of two beat frequencies, Δfᵤₚ and Δf_{dn}. The beat frequencies Δfᵤₚ and Δf_{dn} are related to the frequency difference cause by the range, Δf_{Range}, and the frequency difference cause by the Doppler shift, Δf_{Doppler}, according to the following formulas:

$$Δ {f}_{u p} = Δ {f}_{R a n g e} - Δ {f}_{Doppler} \qquad ( 1 )$$

$$Δ {f}_{dn} = Δ {f}_{R a n g e} + Δ {f}_{Doppler} \qquad ( 2 )$$

Thus, the beat frequencies Δfᵤₚ and Δf_{dn} can be used to differentiate between frequency shifts caused by the range and frequency shifts caused by motion of the measured object. Specifically, Δf_{Doppler} is the difference between the Δfᵤₚ and Δf_{dn} and the Δf_{Range} is the average of Δfᵤₚ and Δf_{dn}.

The range to the target and velocity of the target can be computed using the following formulas:

$$Range = Δ {f}_{R a n g e} \frac{c {T}_{s}}{2 Δ {f}_{s}} \qquad ( 3 )$$

$$Velocity = Δ {f}_{Doppler} \frac{{λ}_{c}}{2} \qquad ( 4 )$$

In the above formulas, λ_{c}=c/f_{c} and f_{c} is the center frequency of the scanning signal. By solving this system of equations for Δf_{Range} and Δf_{Doppler} and substituting those values into equations (3) and (4) respectively, one sees that the range and velocity, shown in equations (5) and (6), are proportional to the average and difference, respectively, of the up-sweep and down-sweep beat frequencies.

$$R = \frac{c {T}_{s}}{4 {B}_{s}} ( Δ {f}_{dn} + Δ {f}_{u p} ) \qquad ( 5 )$$

$$V = \frac{{λ}_{c}}{4} ( Δ {f}_{dn} - Δ {f}_{u p} ) \qquad ( 6 )$$

By employing a counter-chirp mechanism shown in FIG. 2 one can achieve more accurate measurements for range and velocity since the up-sweep and down-sweep beat frequencies are measured simultaneously. This modulation scheme uses two transmitted beams (solid line and long-dashed line) pointed at the same target; each beam yields its respective echo (short-dashed line and dotted line). As a result, the system simultaneously measures both beat notes (Δfᵤₚ and Δf_{dn}) from which it can calculate the range and velocity using equations (5) and (6).

The beat frequencies can be generated, for example, as an analog signal in optical receivers 104 of system 100. The beat frequency can then be digitized by an analog-to-digital converter (ADC), for example, in a signal conditioning unit such as signal conditioning unit 107 in LIDAR system 100. The digitized beat frequency signal can then be digitally processed, for example, in a signal processing unit, such as signal processing unit 112 in system 100.

In some scenarios, to ensure that the beat frequencies accurately represent the range and velocity of the object, beat frequencies can be measured at a same moment in time, as shown in FIG. 2. Otherwise, if the up-chirp beat frequency and the down-chirp beat frequencies were measured at different times, quick changes in the velocity of the object could cause inaccurate results because the Doppler effect would not be the same for both beat frequencies, meaning that equations (1) and (2) above would no longer be valid. In order to measure both beat frequencies at the same time, the up-chirp and down-chirp can be synchronized and transmitted simultaneously using a pair of signals that are multiplexed together to form a combined counter-chirped optical beam.

The analog signal from the optical receivers may be referred to as a baseband signal, which is a continuous analog signal in the time domain. The baseband signal may be sampled by an ADC to generate a series of time domain samples. The time domain samples may be processed to condition the time domain samples for further processing. For example, weighting or filtering may be applied to remove unwanted signal artifacts or to render the signal more tractable for subsequent processing. The time domain samples may be grouped into a number of samples, which are provided to a discrete Fourier transform (e.g., Fast Fourier Transform (FFT)). The time domain samples may be grouped using a series of overlapping FFT windows 208. Each FFT window 208 slides over the time domain samples to create multiple points per second while utilizing longer integration time for better SNR. The discrete Fourier transform transforms each grouping of time domain samples into frequency subbands in the frequency domain, such that the combination of subbands cover the bandwidth of the baseband signal. The frequency domain subbands may be conditioned (e.g., resamples and/or averaged for noise reduction) and then provided to a peak search processor that searches for signal peaks representing detected targets in the FOV of the LIDAR system 100.

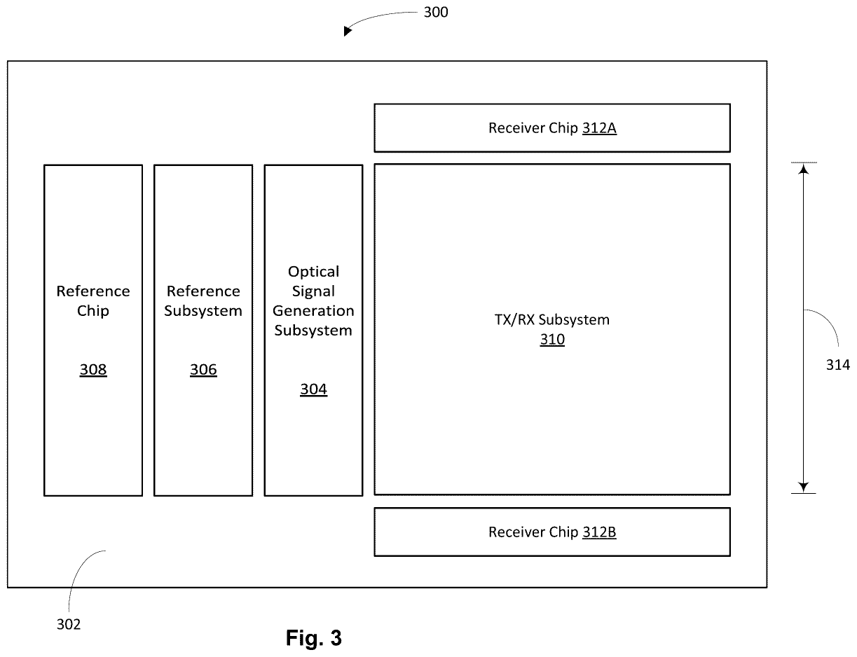

FIG. 3 is a plan view of a sensing system for a FMCW LIDAR system in accordance with some embodiments of the present disclosure. The sensing system 300 includes a plurality of components mounted to a substrate 302 such as a printed circuit board (PCB). It will be appreciated that the relative shapes, sizes, and locations of various components are provided to aid in explaining the present disclosure and are not intended as limiting features of the disclosed techniques. Additionally, the sensing system 300 may include fewer or additional components than shown in FIG. 3.

In the embodiment shown in FIG. 3, the sensing system 300 is implemented as an integrated device, which includes an optical signal generation subsystem 304, reference subsystem 306, reference chip 308, transmit/receive (TX/RX) subsystem 310, and receiver chips 312A and 312B.

The optical signal generation subsystem 304 includes a plurality of optical sources (e.g., lasers) and semiconductor optical amplifiers (SOAs). Each of the optical sources is configured to inject an optical beam into the reference subsystem 306, which forms a feedback loop and to generate control signals that can increase or decrease the frequency of each optical source to maintain linearity. The reference subsystem 306 also includes photodetectors that convert received optical control signals to electronic signals for further processing by the reference chip 308. The reference chip 308 may include transimpedance amplifiers (TIA) that converts the current signals from the photodetectors into analog voltages. The reference chip 308 also includes ADCs to convert the analog voltage signals from the TIAs into digital signals. The digital signals may then be sent to the LIDAR control systems 110 (FIG. 1).

The reference subsystem 306 includes return paths that inject each optical beam back to one or more SOAs of the optical signal generation subsystem 304, which amplify the optical signals and inject the optical beams into the TX/RX subsystem 310. The TX/RX subsystem 310 includes optical components that can further split each optical beam to generate a plurality of output optical beams for transmission into the environment. The sensing system 300 may also include one or more free space optics at the output of the TX/RX subsystem 310, such as polarization rotator (e.g., Faraday rotator, quarter wave plate, etc.), a diffraction component (e.g., prism, diffractive grating, etc.), and others. In some embodiments, the output of the TX/RX subsystem 310 be edge coupled, such that the transmitted optical beams are emitted at the edge of the chip. In other embodiments, the output of the TX/RX subsystem 310 be surface coupled output, such that the transmitted optical beams are emitted from the top surface of the chip (i.e., out of the page).

The TX/RX subsystem 310 also receives the return optical beams and includes photodetectors that convert the return optical signals to electronic signals for further processing by the receiver chips 312A and 312B. The receiver chips 312A and 312B may include transimpedance amplifiers (TIA) that converts the current signals from the photodetectors into analog voltages. The receiver chips 312A and 312B also include ADCs to convert the analog voltage signals from the TIAs into digital signals. The digital signals may then be sent to the signal processing unit 112 (FIG. 1).

The TX/RX subsystem 310 and the reference subsystem 306 are both photonics chips, which can include various waveguides, combiners, splitters, taps, and the like. The photonics chips may be silicon photonics chips that uses silicon as an optical medium and can be made using semiconductor fabrication techniques. The reference chip 308 and receiver chips 312A and 312B are electronic chips that can be made using semiconductor fabrication techniques.

Various configurations are possible for coupling signals between the photonics chips and the electronic chips. For example, the reference chip 308 may be a flip chip, which can be mounted on top of the reference subsystem 306. Similarly, the receiver chips 312A and 312B may be flip chips mounted on top of the TX/RX subsystem 310. In other embodiments, the reference chip 308 and/or the receiver chips 312A and 312B may be mounted to the substrate 302 adjacent to the optical chips. Additionally, in some embodiments, the reference subsystem 306 and the TX/RX subsystem 310 may be separate photonics chips positioned on opposite sides of the optical signal generation subsystem 304. In other embodiments, the reference subsystem 306 and the TX/RX subsystem 310 may form a single photonics chip, with the optical sources and SOAs of the optical signal generation subsystem 304 integrated within the silicon chip (monolithic integration) or mounted on top of the silicon chip as separate flip chips.

As described further below in relation to the following figures, the sensing system 300 is configured to generate multiple optical beams in a FMCW LIDAR system. For example, depending on the design details of a specific implementation, the sensing system may be configured to generate several hundred optical beams simultaneously. Although the sensing system 300 and other components thereof may be any suitable size, in some embodiments, the width 314 of the of the TX/RX subsystem 310 may be approximately 15 to 20 mm.

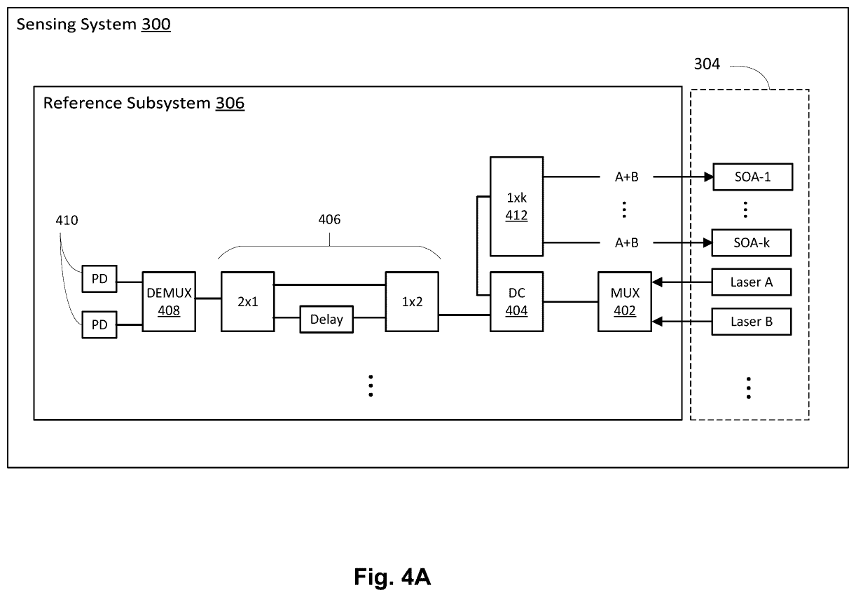

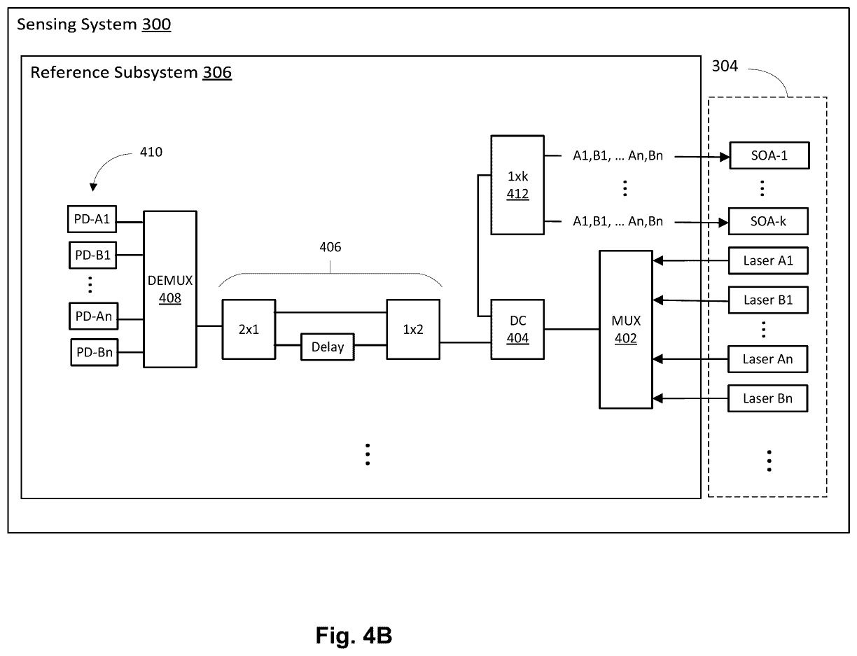

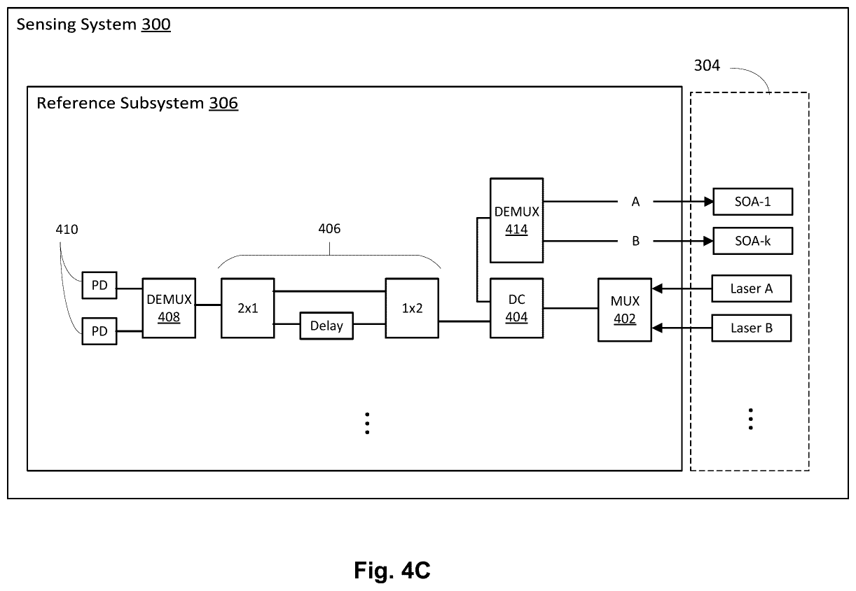

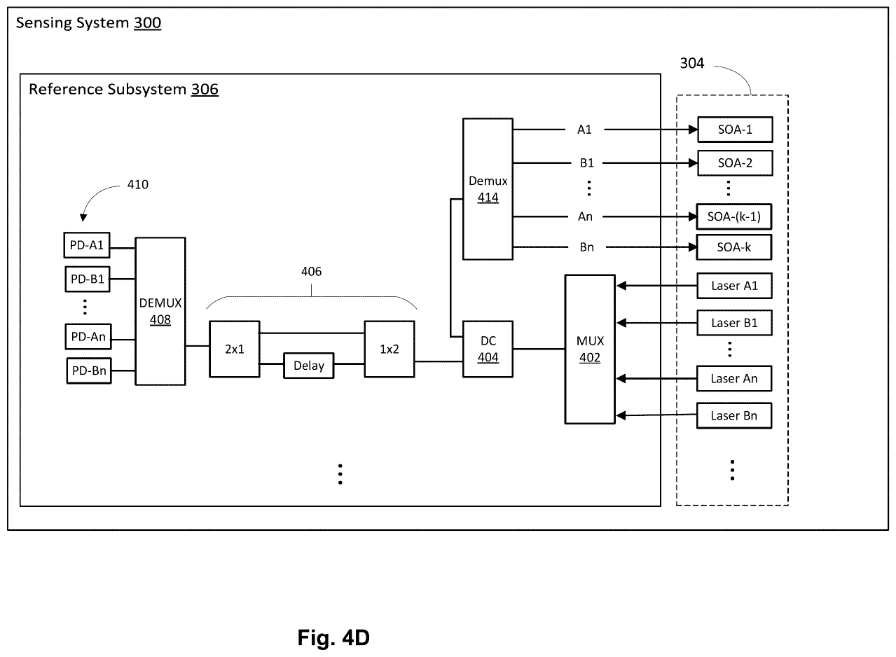

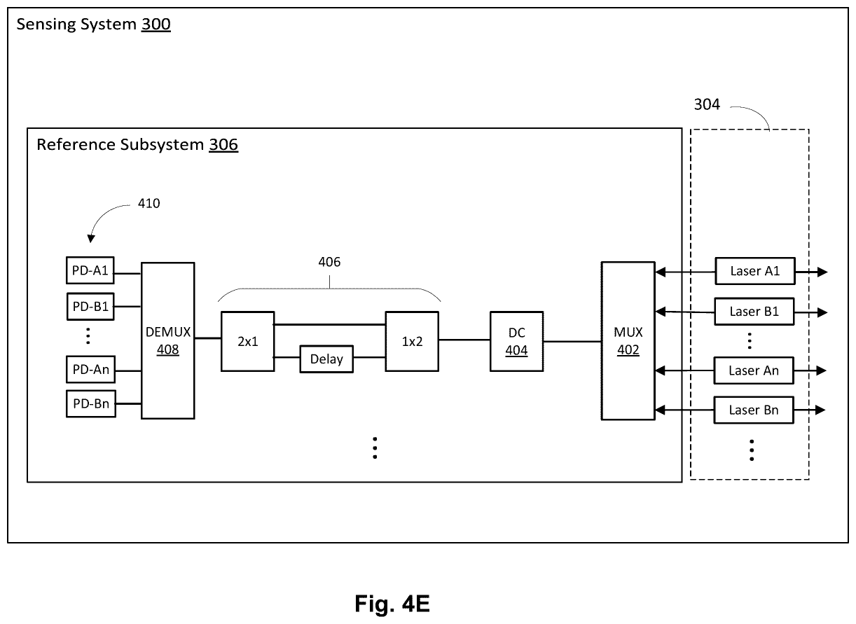

FIG. 4A depicts one example of the reference subsystem 306 in accordance with some embodiments of the present disclosure. In the example embodiment shown in FIG. 4A, the optical signal generation subsystem 304 includes a pair of optical sources referred to as laser A and laser B, where signals A and B form a signal pair. Within the pair of optical signals, one of the optical signals is controlled to form an up chirp and the other optical signal in the pair is configured to form a down chirp. The optical signals within the pair may be combined into a single counter-chirped optical beam prior to transmission.

Laser A and laser B generate optical signals that are input to an optical multiplexer (MUX) 402, which combines the A and B optical signals into one output. The output of the MUX 402 is coupled to a direction coupler (DC) 404 which splits a portion of the combined signal to a feedback loop that includes an optical interferometer 406, (e.g., Mach-Zehnder Interferometer (MZI)). The optical interferometer splits 406 the combined signal into two different length paths and then recombines the light into a single path. Any instantaneous difference in the frequency of the recombined optical signals can be used to produce a beat frequency. The combined optical signals are then separated into the separate A and B signal components by the optical demultiplexer (DEMUX) 408 and sent to separate photodetectors 410. The beat frequencies detected by the photodetectors 410 are provided to the reference chip 308 (FIG. 3), which uses the beat frequencies to generate voltage feedback signals for controlling each respective laser.

The other output of the DC 404 sends a portion of the combined signals on a return path that delivers the optical signals to a number of SOAs, labeled SOA-1 and SOA-k. In this embodiment, the output of the DC 404 is input to a 1×k distributor 412 which distributes the combined optical signal between k outputs to form k combined optical signals. As used herein, the term distributor refers to an optical splitter or an optical switch. Examples of splitters include Fused Biconical Taper (FBT) splitters, Planar Lightwave Circuit (PLC) splitters, optical taps, and others. Although depicted as a di In the case of a splitter, the 1×k distributor 412 may divide the power equally between the outputs or may divide the power unequally between the outputs (e.g., to favor certain regions of the FOV). In the case of a switch, the 1×k distributor 412 may be controlled to activate the k SOAs in sequence according to a scanning pattern. The use of a switch may be useful to increase the strength of the optical signal compared to embodiments that use a splitter.

Each combined optical signal output by the distributor 412 is sent to a separate SOA. In the embodiment shown in FIG. 4A, the distributor 412 distributes the combined optical signal between k outputs, which can be further split downstream to form multiple output optical beams. The distributor 412 may distribute the combined optical signal into any suitable number of additional combined optical signals. For example, the distributor 412 may be a 1×4 distributor, 1×8 distributor, etc., wherein each output of the distributor 412 is sent to a separate SOA. Each SOA receives the input optical signals, amplifies them, and inject the signals into the TX/RX subsystem 310 for further processing as described below. The components of the optical signal generation system 304 and reference subsystem 306 may be repeated any number of times for processing additional laser pairs in the same manner described above. Additionally, although the systems described herein use a pair of lasers, which are combined to generate a combined signal (A+B), embodiments of the present techniques can also be implemented with one or more individual lasers rather than counter-chirped laser pairs.

FIG. 4B depicts another example of the reference subsystem 306 in accordance with some embodiments of the present disclosure. The reference subsystem 306 shown in FIG. 4B operates in the same manner as described for the reference subsystem of FIG. 4A except that it receives a plurality of optical signal pairs from a plurality of optical sources of the optical signal generation subsystem 304, labeled laser A1, B1 to laser An, Bn, where n can be any suitable number. In this example, A1 and B1 form a first signal pair and An and Bn form the nth signal pair. The n signal pairs are combined by the MUX 402 and are separated into separate signal components (A1, B1, An, Bn) by the DEMUX 408 to be sent to separate photodetectors 410, labeled PD-A1, PD-B1, PD-An, PD-Bn. For the return path, the combined optical signals are output by the 1×k distributor 412 to the SOAs, SOA-1 to SOA-k. The components of the optical signal generation system 304 and reference subsystem 306 may be repeated any number of times for processing additional laser pairs in the same manner described above.

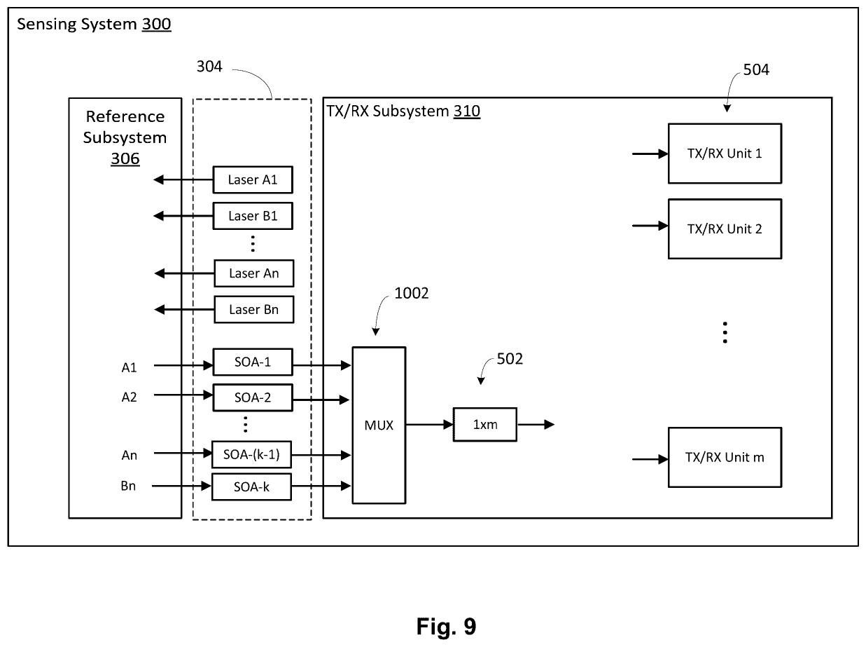

FIG. 4C depicts another example of the reference subsystem 306 in accordance with some embodiments of the present disclosure. The reference subsystem shown in FIG. 4C operates in the same manner as described for the reference subsystem of FIG. 4A except that the optical signals sent back to the SOAs in the return path are separated according to the optical wavelength instead of being combined. As shown in FIG. 4C, the output of the DC 404 is sent to a DEMUX 414 which separates the combined A+B signal by optical wavelength, with the A signal provided to the input of one SOA and the B signal provided to the input of a separate SOA. Since the gain of each SOA may be controlled separately, this embodiment may be used to equalize the amplitudes of the A and B signals to account for differences in the laser outputs or imbalances in other components. The equalized A and B signals may then be combined in the TX/RX subsystem 310 as described in relation to FIG. 9. The components of the optical signal generation system 304 and reference subsystem 306 may be repeated any number of times for processing additional laser pairs in the same manner described above.

FIG. 4D depicts another example of the reference subsystem 306 in accordance with some embodiments of the present disclosure. The reference subsystem shown in FIG. 4D operates in the same manner as described for the reference subsystem of FIG. 4C except that it receives a plurality of optical signal pairs from a plurality of optical sources of the optical signal generation subsystem 304, labeled laser A1, B1 to laser An, Bn, where n can be any suitable number. In this example, A1 and B1 form a first signal pair and An and Bn form the nth signal pair. The n signal pairs are combined by the MUX 402 and are separated into separate signal components (A1, B1, An, Bn) by the DEMUX 408 to be sent to separate photodetectors 410, labeled PD-A1, PD-B1, PD-An, PD-Bn.

For the return path, the DEMUX 414 separates the combined signals by optical wavelength, with each signal provided to the input of one the k SOAs. As with the embodiment described in relation to FIG. 4C, the gain of each SOA may be controlled to equalize the amplitudes of n signal pairs to account for differences in the laser outputs or other imbalances. The equalized optical signals may then be combined in the TX/RX subsystem 310 as described in relation to FIG. 9. The components of the optical signal generation system 304 and reference subsystem 306 may be repeated any number of times for processing additional laser pairs in the same manner described above.

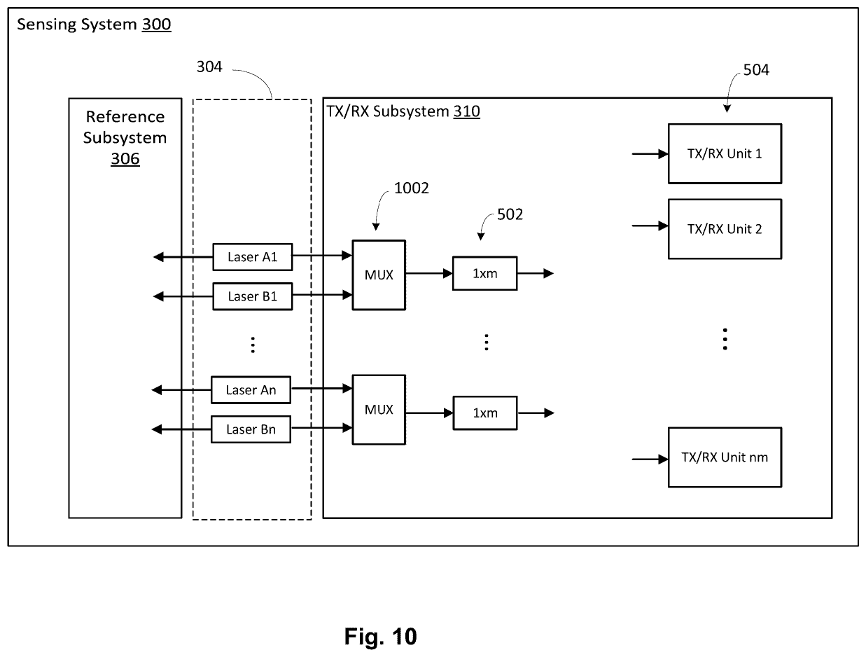

FIG. 4E depicts another example of the reference subsystem 306 in accordance with some embodiments of the present disclosure. The reference subsystem shown in FIG. 4E operates in the same manner as described for the reference subsystem of FIG. 4B or 4D except that the optical sources (lasers A1, B1 . . . An, Bn) are bidirectional. Accordingly, a portion of the signal generated by each optical source is injected into the MUX 402 and a remaining portion of the optical signal is injected into the TX/RX subsystem 310 for further processing as described in relation to FIG. 10. In this embodiment, the return path formed by the directional coupler 404 and the 1×k distributor 412 (FIGS. 4A and 4B) or DEMUX 414 (FIGS. 4C and 4D) can be eliminated. The components of the optical signal generation system 304 and reference subsystem 306 may be repeated any number of times for processing additional laser pairs in the same manner described above.

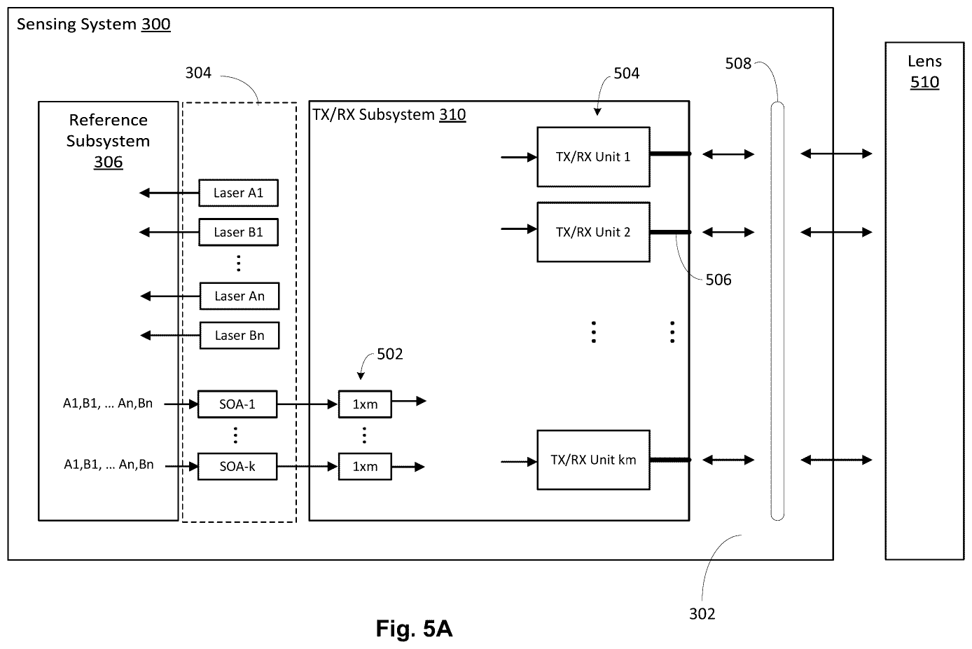

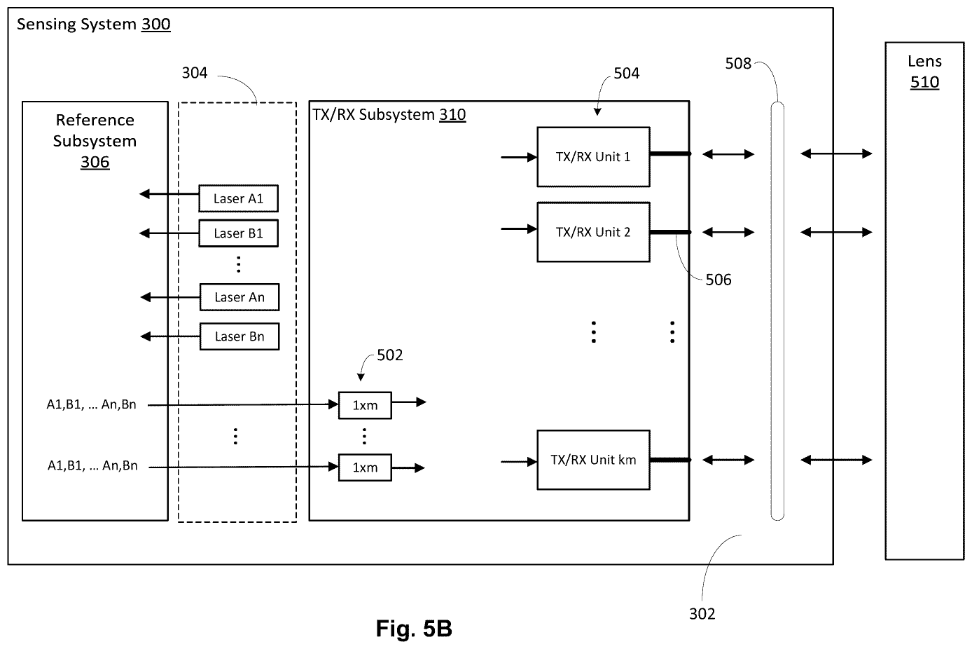

FIG. 5A depicts one example of a sensing system in accordance with some embodiments of the present disclosure. In this example, the optical signal generation subsystem 304 and reference subsystem 306 operate as described in relation to FIG. 4A or 4B. The example TX/RX subsystem 310 includes a plurality of 1×m distributors 502 and a plurality of TX/RX units 504. The output of each SOA is sent to the input to one of the 1×m distributors 502 (e.g., splitter or switch), which receives the combined optical signals and distributes the combined optical signal between m outputs. As shown in FIG. 5A, the output of each SOA includes n signal pairs (A1, B1 . . . An, Bn). However, it will be appreciated that the TX/RX subsystem 310 can also be configured so that each SOA outputs a single signal pair (i.e., n=1).

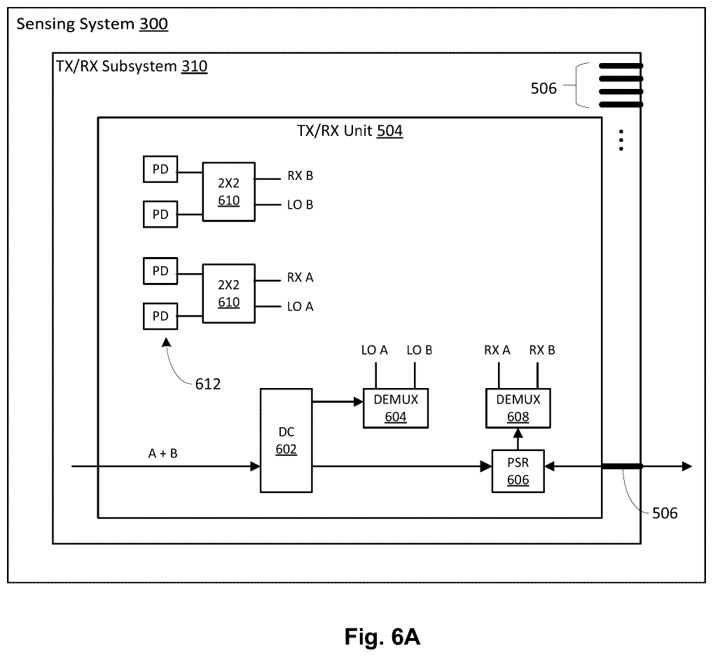

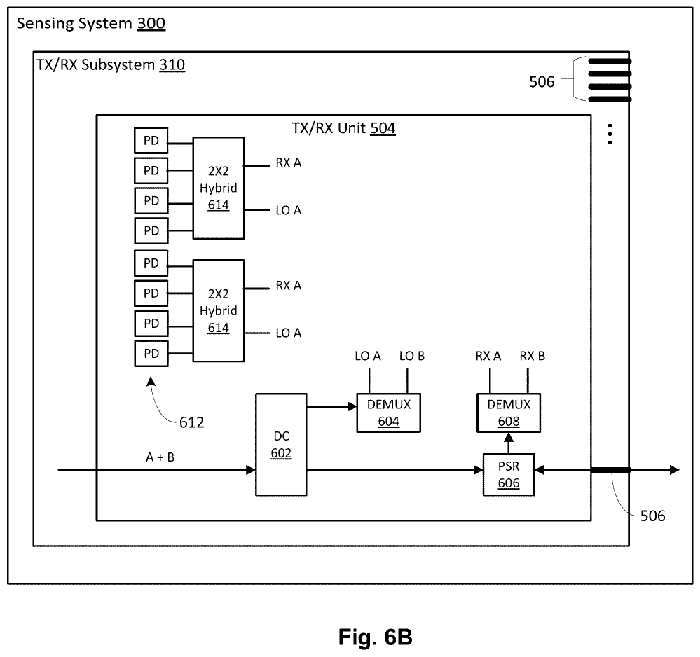

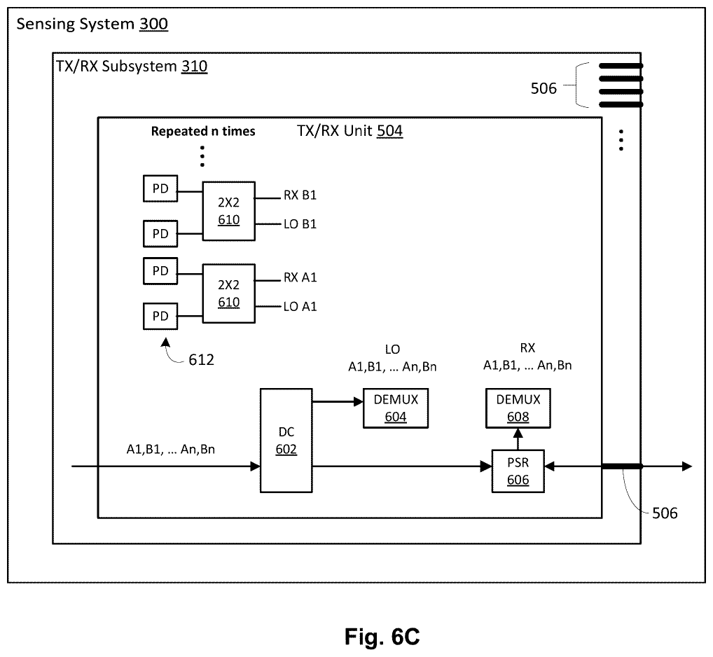

Each of the distributor outputs is sent as an input signal to one of the TX/RX units 504, which further processes the input signal to generate an output optical beam. The output of the TX/RX subsystem 310 shown in FIG. 5A is edge coupled and includes an array of TX/RX ports 506 for transmitting the output optical beam and receiving the return optical beam. In this embodiment, each TX/RX unit 504 is coupled to a single TX/RX port 506. Each TX/RX unit 504 also includes components for generating beat frequencies from the output and return optical beams. Example TX/RX units are described further in relation to FIGS. 6A, 6B, and 6C.

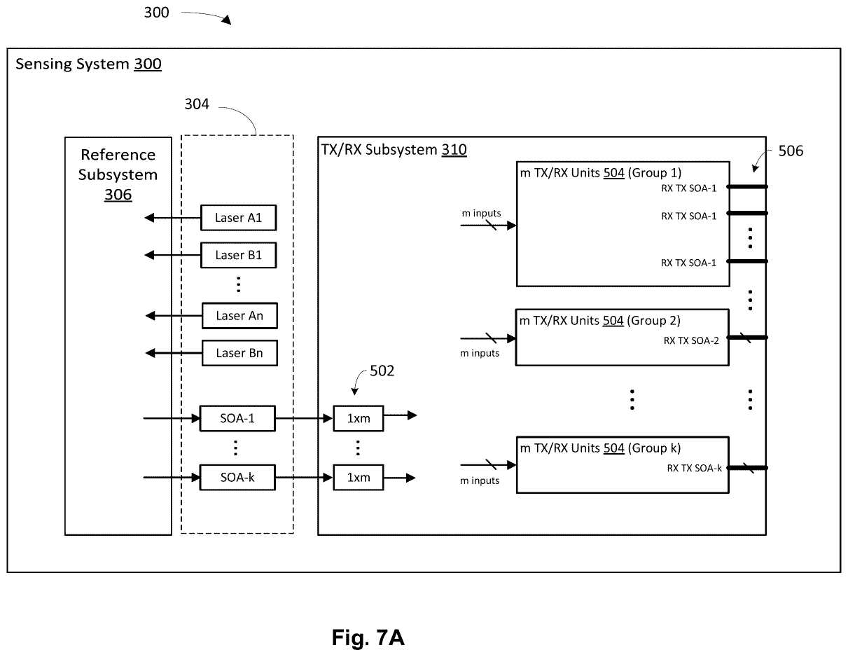

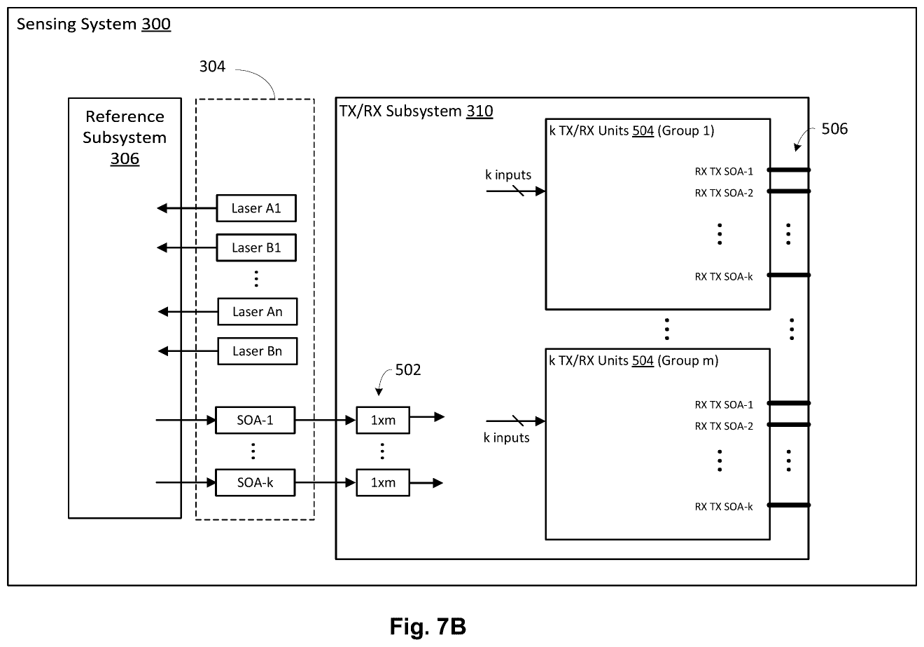

The routing connections between the distributors 502 and the TX/RX units 504 are not shown. However, it will be appreciated that the TX/RX subsystem 310 will include a plurality of waveguides, where each waveguide couples one of the distributor outputs to a corresponding TX/RX unit 504. The specific routing configuration may vary depending on the design details of a specific implementation. Example routing configurations are described further in relation to FIGS. 7A and 7B.

In this example, the sensing system 300 also includes a polarization rotator 508 (e.g., quarter-wave plate (QWP)), which may be mounted to the substrate 302 and positioned at the output of the TX/RX subsystem 310. The polarization rotator 508 rotates the polarizations of the output and return optical beams so the return optical beam received at the TX/RX unit 504 is rotated 90 degrees compared to the optical beam output by the TX/RX unit 504. This enables separation of the outgoing and return optical beams inside the TX/RX units 504. The sensing system 300 may be positioned to project the laser beams into additional free-space optics, including a lens 510. The outgoing optical beams may be spread out by the lens 510 to cover a desired angular range, which will depend on the focal length of the lens. Return optical beams are collimated and directed back to the same TX/RX unit 504 via the corresponding TX/RX port 506. The lens 510 may be any suitable type of lens including any suitable type of positive lens (also known as a converging lens) or negative lens (also known as a diverging lens). The transmitted optical beams may also be directed to a scanning system, including a dual-axis scanner or a single-axis scanner.

In the example shown in FIG. 5A, there are n signal pairs, k SOAs, and m outputs for each distributor 502. In embodiments where the distributor 502 is a splitter, this results in n×k×m output optical beams that can be emitted by the TX/RX subsystem 310 simultaneously. An example implementation having 2 laser pairs (n=2), 8 SOAs (k=8) and 1×40 distributors (m=40) results in 320 TX/RX units 504 and 640 separate optical beams. Given an output width of around 15 to 20 mm, the pitch of the TX/RX ports 506 may be approximately 30 to 40 TX/RX ports per inch.

In embodiments where the distributor 502 is a switch, each 1×m distributor 502 switches the combined optical signal received from its respective SOA between m TX/RX units 504. Each 1×m distributor 502 may be controlled to activate the m TX/RX units in sequence according to a scanning pattern. In this way, the FOV (or one dimension of the FOV) can be scanned without the use of scanning mirrors or other moving parts. Such embodiments may be useful to increase the strength of the optical signal compared to embodiments in which the distributor 502 is a splitter, which divides the optical signal power between m outputs. By switching the output of each SOA rather than splitting, the signal strength of each output optical beam may be close to the full signal strength of the corresponding SOA (taking into account losses).

FIG. 5B depicts another example of a sensing system in accordance with some embodiments of the present disclosure. The TX/RX subsystem 310 of FIG. 5B includes the same components and operates the same way as the TX/RX subsystem 310 shown in FIG. 5A except that the combined optical signals are received from the reference subsystem 306. In this example, the optical signal generation subsystem 304 does not include the SOAs, and the combined optical signals are sent from the 1×k distributor 412 (FIG. 4A or 4B) to the 1×m distributors 502 through a waveguide. In such embodiments, the optical sources may include integrated SOAs.

FIG. 6A is an example embodiment of a TX/RX unit 504 that can be included in the TX/RX subsystem 310 in accordance with some embodiments of the present disclosure. The TX/RX unit 504 receives one of the combined optical signals (A+B) from one of the distributors 502 shown in FIG. 5A or 5B as an input signal. The combined optical signal is input to a directional coupler (DC) 602, which directs a portion of the combined signal to a DEMUX 604 to generate a local oscillator (LO) signal. The DEMUX 604 splits the combined signal into LO A and LO B. The other output of the DC 602 is passed through a polarization splitter rotator (PSR) 606, which directs the output signal to the TX/RX port 506 to transmit an outgoing optical beam.

When the transmitted optical beam hits a target, a portion of the beam is returned back to the LIDAR system 100 as a return optical beam, which is received at the same TX/RX port 506 506 and returned to the PSR 606. Due to the rotated polarization of the return optical signal, the PSR 606 directs the return optical signal to the DEMUX 608, which splits the signal into its separate wavelength components, RX A and RX B. The return signals RX A and RX B are combined with their respective LO signals by respective 2×2 splitter/combiners 610 and sent to the photodiodes 612, which generate the beat frequencies. The signals measured by the photodiodes 612 can be sent to one of the receiver chips 312A or 312B and used to measure distance, velocity, or other factors about the environment at the target point as described above. The plurality of TX/RX units 504 enable several range and velocity measurements to be performed simultaneously or near simultaneously to generate a point cloud representing the state of the environment at a given moment. Each instance of the point cloud may be referred to as a frame. The LIDAR system may be capable of generating several frames of data per second.

FIG. 6B is another example embodiment of a TX/RX unit 504 that can be included in the TX/RX subsystem 310 in accordance with some embodiments of the present disclosure. The TX/RX unit 504 of FIG. 6B includes the same components and operates the same way as the TX/RX unit 504 shown in FIG. 6A except that instead of combining the return signals and their local oscillator signals using a 2×2 splitter/combiner, the return signals and their local oscillator signals are combined using 2×2 optical hybrids. The optical hybrids generate a pair of outputs that are rotated in phase by 90 degrees, enabling the use of In-phase/Quadrature (I/Q) detection scheme.

FIG. 6C is another example embodiment of a TX/RX unit 504 that can be included in the TX/RX subsystem 310 in accordance with some embodiments of the present disclosure. The TX/RX unit 504 of FIG. 6C includes the same components and operates the same way as the TX/RX unit 504 shown in FIG. 6A except that the combined optical signals include a plurality of optical signal pairs (A1, B1 . . . An, Bn). These combined optical signals may be generated as described in relation to FIG. 4B. The return signals (RX A1, B1 . . . An, Bn) are combined with their respective LO signals (LO A1, B1 . . . An, Bn) by respective 2×2 splitter/combiners 610 and sent to the photodiodes 612. It will be appreciated that the 2×2 splitter/combiners 610 and the photodiodes 612 will be repeated n times for each of the n signal pairs.

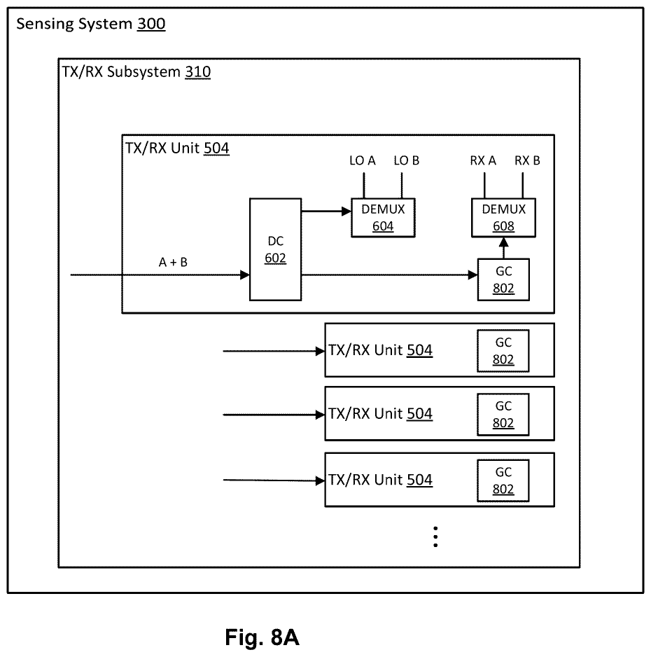

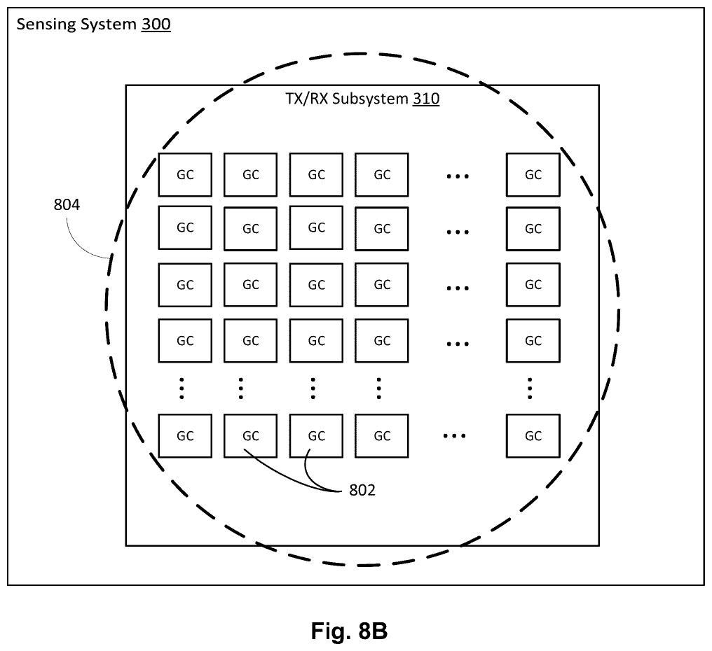

FIG. 7A illustrates an example optical signal routing configuration that may be used in the TX/RX subsystem 310 in accordance with some embodiments of the present disclosure. The sensing system 300 shown in FIG. 7A is the same as the sensing system 300 shown in FIG. 5A. However, it will be appreciated that the same routing scheme may also be used in other embodiments, including any of the embodiments shown in FIGS. 8A through 12. The TX/RX subsystem 310 includes the same plurality of TX/RX units 504 shown in FIGS. 5A and 5B. However, for ease of explanation, the TX/RX units 504 are shown as divided into groups of adjacent TX/RX units 504 labeled Group 1, Group 2, etc., for a total of k TX/RX groups, which corresponds with the number of SOAs.

In the embodiment of FIG. 7A, the output of each SOA is routed to a group of adjacent TX/RX units 504. Accordingly, each group includes m TX/RX units 504 and receives m inputs, which corresponds with the m outputs of the corresponding 1×m distributor 502. For example, as shown in FIG. 7A, the first group of TX/RX units (Group 1) includes m TX/RX ports 506, where each output optical beam originates from SOA-1, the second group of TX/RX units (Group 2) includes m TX/RX ports 506, where each output optical beam originates from SOA-2, and so on.

Routing the output of each SOA to adjacent TX/RX units 504 helps to avoid crossings between the waveguides. However, in some cases it may be beneficial to power down one or more SOAs, which may reduce the FOV of the LIDAR system. For example, powering down SOA-1 would eliminate an entire block of optical beams at the outer edge of the FOV.

FIG. 7B illustrates another example optical signal routing configuration that may be used in the TX/RX subsystem 310 in accordance with some embodiments of the present disclosure. As described above in relation to FIG. 7A, the TX/RX subsystem 310 includes the same plurality of TX/RX units 504 shown in FIGS. 5A and 5B, which are divided into groups of adjacent TX/RX units 504 labeled Group 1, Group 2, etc. However, in the example of FIG. 7B, the outputs of the distributors 502 are interleaved between the groups. Accordingly, each group includes k TX/RX units 504 and receives k inputs, which corresponds with the number of SOAs. The number of TX/RX groups is equal to the number outputs for each 1×m distributor 502, for a total of m TX/RX groups.

In this embodiment, each 1×m distributor 502 provides one input to each TX/RX group. For example, as shown in FIG. 7B, each group of TX/RX units includes k TX/RX ports 506, where each output optical beam originates from a different one of the k SOAs. Interleaving the outputs of each SOA in this manner may introduce crossings between the waveguides. However, the FOV of the LIDAR system would be less effected if one or more SOAs are deactivated. For example, deactivating SOA-1 would eliminate one of the optical beams from each TX/RX group rather than an adjacent block of optical beams.

FIG. 8A is another example embodiment of a TX/RX unit 504 that can be included in the TX/RX subsystem 310 in accordance with some embodiments of the present disclosure. The TX/RX unit 504 may be used to implement a sensing system 300 that uses a surface coupled output, in which the transmitted optical beams are emitted from the top surface of the chip (i.e., out of the page). Each of the TX/RX units 504 may be the same as the TX/RX units 504 shown in FIG. 6A, 6B, or 6C, except that instead of a PSR 606 as in FIGS. 6A, 6B, and 6C, the TX/RX unit 504 includes a vertical grating coupler (GC) 802. The grating coupler 802 may be formed by a diffractive grating structure disposed on the top of photonics chip, which changes the direction of light from horizontal (i.e., parallel to the plane of the chip) to vertical (i.e., perpendicular to the plane of the chip).

As described above in relation to FIGS. 6A, 6B, and 6C the directional coupler (DC) 602, directs a portion of the combined signal (A+B) to a DEMUX 604 to generate local oscillator (LO) signals LO A and LO B. The other output of the DC 602 is sent to the GC 802, which directs the output optical signal vertically through the top surface of the chip (i.e., out of the page) to generate the outgoing optical beam.

When the transmitted optical beam hits a target, a portion of the beam is returned back to the LIDAR system 100 as a return optical beam, which is received at the same GC 802. The GC directs the return optical signal to the DEMUX 608, which splits the signal into its separate wavelength components, RX A and RX B. The return signals RX A and RX B and their respective LO signals may be combined and used to generate baseband signals as described above in relation to FIGS. 6A, 6B and/or 6C. For the sake of simplifying the description, some components of the TX/RX units 504 are not shown. However, it will be appreciated that each of the TX/RX units 504 shown in FIG. 8A may also include the components described in relation to FIGS. 6A, 6B and/or 6C depending on the type of measurements to be implemented (e.g., direct or I/Q). Additionally, although the TX/RX unit 504 is shown as receiving a single signal pair (A+B), it will be appreciated that the combined signal may also include n signal pairs (A1, B1, . . . An, Bn) as described in relation to FIG. 6C. The GCs 802 may be positioned to form a straight line as shown in FIG. 8A or a two-dimensional grid as shown in FIG. 8B.

FIG. 8B is an example embodiment of a TX/RX subsystem 310 with a surface coupled output in accordance with some embodiments of the present disclosure. The TX/RX subsystem 310 of FIG. 8B includes the TX/RX units 504 as described above in relation to FIG. 8A. For the sake clarity, only the GCs 802 are shown. However, it will be appreciated that each GC 802 will be a component of one of the TX/RX units 504. The sensing system 300 may also include a lens 804, which is disposed over the surface of the TX/RX subsystem 310. The lens 804 may be configured to spread the outgoing optical beams emitted by the GCs 802. In some embodiments, the number of GCs may be sufficient to cover the entire FOV of the LIDAR system with a suitable point density. In this case, the LIDAR system 100 may be implemented without an optical scanner that uses moving parts to sweep the lasers over the environment. In some embodiments, the GCs 802 may cover a single dimension of the FOV and a single-axis scanning system can be used to sweep the lasers over the other dimension of the FOV.

Additionally, the sensing system 300 may be configured to switch some GCs 802 on or off so that different subsets of GCs 802 may be active at different stages of the measurement process. For example, in a single-axis scanning system, one line of GCs 802 may be activated and swept over the scanning axis. Additional GCs 802 may be activated to increase the angular resolution along the scan axis for a certain region of interest in the point cloud. In situations where the SNR falls below a threshold, the integration time for generating points may be increased by slowing the rotation of the scanning mirror, while activating additional lines of GCs 802 to maintain the same angular resolution.

Various techniques may be used to activate or deactivate targeted GCs 802. For example, specific laser pairs or SOAs may activated or deactivated. Additionally, the activation or deactivation of targeted GCs 802 may be accomplished by implementing the 1×k distributor 412 (FIGS. 4A and 4B) and/or the 1×m distributors 502 as switches.

FIG. 9 is another example of a sensing system in accordance with some embodiments of the present disclosure. The sensing system 300 of FIG. 9 may be substantially similar to the sensing system described in relation to FIGS. 5A and 5B, except that the signal pairs are combined in the TX/RX subsystem 310 rather than the reference subsystem 306. The reference subsystem 306 shown in FIG. 9 may operate as described in relation to FIG. 4C or 4D, such that each SOA receives a single optical signal (e.g., An or Bn) rather than a combined optical signal. Each optical signal is injected individually into the TX/RX subsystem 310 and combined into signal pairs (A1, B1 . . . An, Bn) by an optical multiplexer (MUX) 902 included in the TX/RX subsystem 310. The output of the multiplexer 902 is sent to the 1×m distributor 502 (e.g., splitter or switch), which receives the combined signal pairs and distributes them to m TX/RX units 504.

The embodiment shown in FIG. 9 may be useful to help balance the amplitudes of the A and B signals of each signal pair. For example, imbalances between the lasers or components of the reference subsystem 306 may cause the A signal and B signal to have unequal magnitudes. In such cases, the gains of the SOAs can be adjusted to rebalance the signal magnitudes before being combined.

The embodiment shown in FIG. 9 may be combined with any of the other embodiments described herein. For example, the TX/RX units 504 may process the received optical signals as described above in relation to FIGS. 6A, 6B, and/or 6C. Furthermore, although not shown, the TX/RX ports of the TX/RX subsystem 310 may be edge coupled as described in relation to FIG. 5 or surface coupled as described in relation to FIGS. 8A and 8B. Additional combinations are also possible.

FIG. 10 is another example of a sensing system in accordance with some embodiments of the present disclosure. The sensing system 300 of FIG. 10 is similar to the sensing system described in relation to FIG. 9, except that the optical sources are bidirectional as described in relation to FIG. 4E. Each optical signal is injected individually into the TX/RX subsystem 310 and combined into signal pairs (A1, B1 . . . An, Bn) by optical multiplexers (MUXs) 1002 included in the TX/RX subsystem 310. In the embodiment shown in FIG. 10, each signal pair is input to a separate MUX 1002. The output of each multiplexer 1002 is sent to the 1×m distributor 502 (e.g., splitter or switch), which receives the combined signal pairs and distributes them to m TX/RX units 504, for a total of n×m TX/RX units 504, which corresponds with the number of laser pairs multiplied by the number of outputs for each 1×m distributor 502.

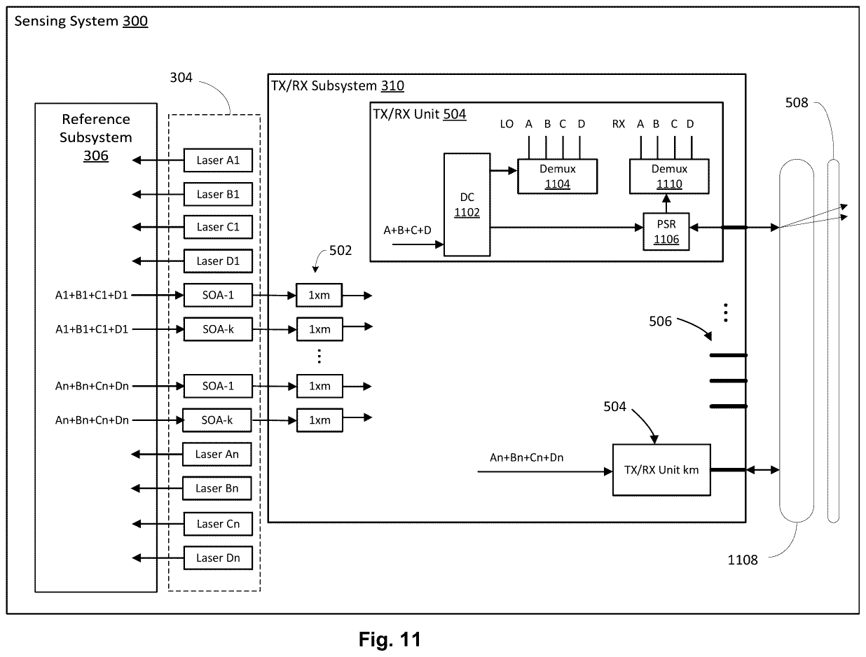

FIG. 11 depicts another example of a sensing system in accordance with some embodiments of the present disclosure. In this example, each combined optical signal transmitted by the sensing system 300 includes fours optical signals originating from four different optical sources (e.g., laser A1, B1, C1, and D1). The A signals and B signals form a first counter-chirped signal pair and the C signals and D signals form a second counter-chirped signal pair, where the A and B signals are generated at a first optical wavelength and the C and D signals are generated at a second optical wavelength different from the first optical wavelength. The reference subsystem 306 may operate as described in relation to FIG. 4B.

The example TX/RX subsystem 310 includes a plurality of 1×m distributors 502 (e.g., splitter or switch) and a plurality of TX/RX units 504. The output of each SOA is sent to the input of one of the 1×m distributors 502, which receives the combined optical signal (i.e., A+B+C+D) and distributes the combined optical signals between m outputs. Each of the distributor outputs is sent to one of the TX/RX units 504, which further processes the received optical signal to generate an output optical beam. The output of the TX/RX subsystem 310 shown in FIG. 11 is edge coupled and includes an array of TX/RX ports 506 for transmitting the output optical beam and receiving the return optical beam. In the depicted embodiment, each TX/RX unit 504 is coupled to a single TX/RX port 506.

Each TX/RX unit 504 receives one of the combined optical signals (A+B+C+D) from one of the distributors 502. The combined optical signal is input to a directional coupler (DC) 1102, which directs a portion of the combined signal to a DEMUX 1104 to generate local oscillator (LO) signals LO A, LO B, LO C, and LO D. The other output of the DC 1102 is passed through a polarization splitter rotator (PSR) 1106, which directs the output signal to the TX/RX port 506 to generate an outgoing optical beam.

In this embodiment, the sensing system 300 also includes a diffraction device 1108 (e.g., diffraction grating, prism, etc), which may be positioned adjacent to the polarization rotator 508. Diffraction devices such as diffraction gratings diffract light into separate beams traveling in different directions (i.e., different diffraction angles) depending, in part, on the wavelength of the incident light. Accordingly, the A and B signals will form one outgoing optical beam and the C and D signals will form another outgoing beam traveling at a different angle. In this way, the combined optical signal (A+B+C+D) is split into two separate optical beams (A+B and C+D) to create more scan lines.

When the transmitted optical beam hits a target, a portion of the beam is returned back to the LIDAR system 100 as a return optical beam, which is received at the same TX/RX port 506 506 and returned to the PSR 606. If both outgoing optical beams hit a target, the separate beams will be recombined by the diffraction device 1108. The PSR 1106 directs the return optical signals to the DEMUX 1110, which splits the signal into its separate wavelength components, RX A, RX B, RX C, and RX D.

The return signals RX A, RX B, RX C, and RX D are combined with their respective LO signals and used to generate beat frequencies as described above in relation to FIGS. 6A and/or 6B. For the sake of simplifying the description, some components of the TX/RX units 504 are not shown. However, it will be appreciated that each of the TX/RX units 504 shown in FIG. 11 may also include the components like those described in relation to FIGS. 6A, 6B and/or 6C.

The embodiment shown in FIG. 11 may be combined with any of the other embodiments described herein. For example, the routing between the distributors 502 and the TX/RX units 504 may be configured as described above in relation to FIGS. 7A and 7B. Furthermore, although FIG. 11 depicts an edge coupled embodiment, the TX/RX ports of the TX/RX subsystem 310 may also be surface coupled as described in relation to FIGS. 8A and 8B. Additional combinations are also possible.

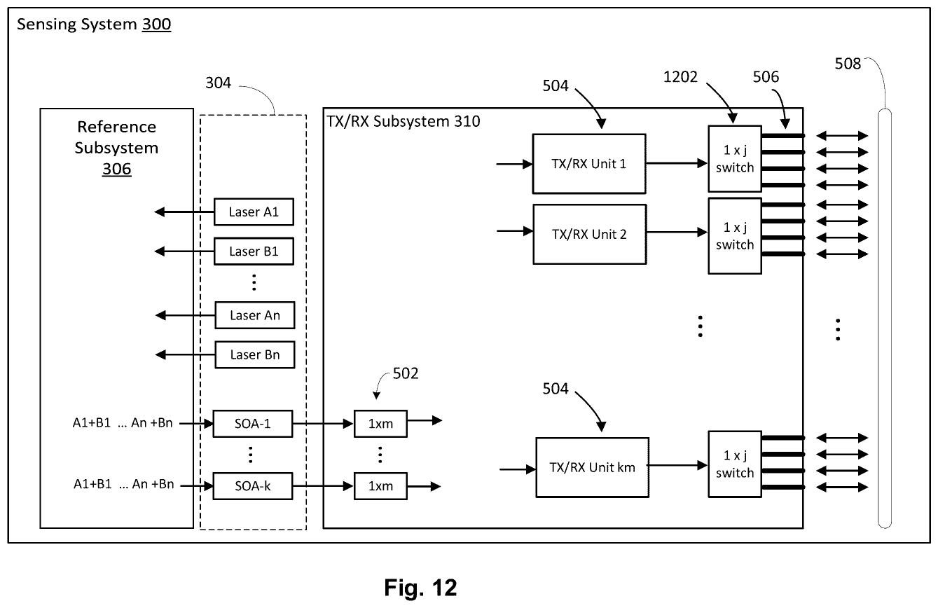

FIG. 12 is another example of a sensing system in accordance with some embodiments of the present disclosure. The sensing system 300 of FIG. 12 may be substantially similar to the sensing system described in relation to FIGS. 5A and 5B, except that the output of each TX/RX unit 504 is coupled to a 1×j switch 1202. The output of each TX/RX unit 504 is sent to the input to one of the 1×j switches 1202, which receives the combined optical signal (A+B) and switches the combined optical signal to one of j different TX/RX ports 506. Each 1×j switch 1202 may be controlled to direct the combined optical signal to the j TX/RX ports 506 in sequence according to a scanning pattern.

In the embodiment shown in FIG. 12, there are n laser pairs, k SOAs, m outputs for each 1×m distributor 502, and k×m TX/RX units, each of which is coupled to j TX/RX ports 506, resulting in n×k×m×j individual optical beams that can be generated by the sensing system 300. The configuration shown in FIG. 12 may be used to further increase the number of transmitted optical beams without loss of signal strength. Additionally, the configuration shown in FIG. 12 may be used to reduce the number of TX/RX units 504 needed to generate a specific number of optical beams. In other words, an implementation with a given number of TX/RX ports 506 can be implemented using a number of TX/RX units 504 equal to the number of TX/RX ports divided by j. This may result in increased signal strength of each beam and simplification of the routing between the distributor 502 and the TX/RX units 504 as compared to the example implementation described in relation to FIG. 5A.

The embodiment shown in FIG. 12 may be combined with any of the other embodiments described herein. For example, the routing between the distributors 502 and the TX/RX units 504 may be configured as described above in relation to FIGS. 7A and 7B. Furthermore, although FIG. 11 depicts an edge coupled embodiment, the TX/RX ports of the TX/RX subsystem 310 may also be surface coupled as described in relation to FIGS. 8A and 8B. Additional combinations are also possible.

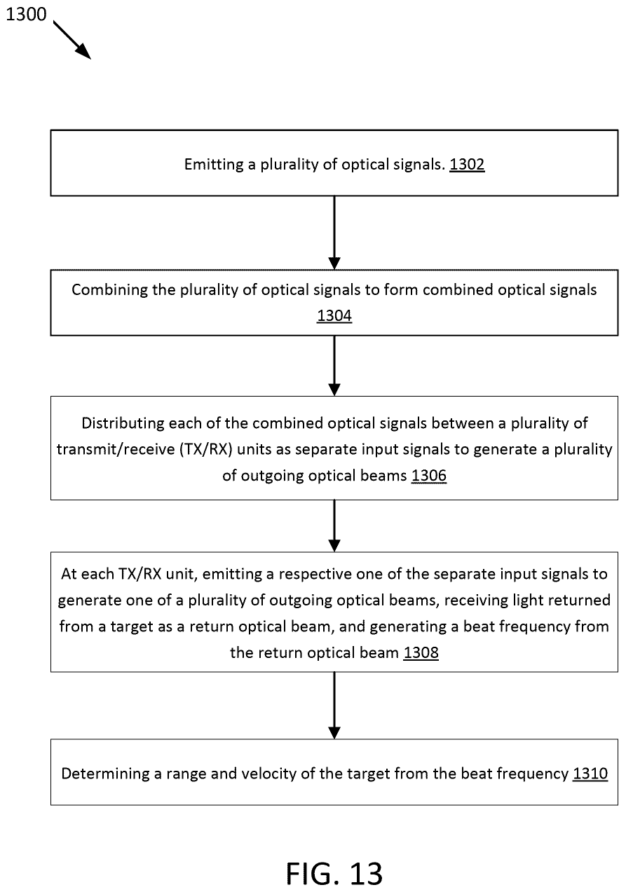

FIG. 13 is a process flow diagram of a method of operating a LIDAR system in accordance with some embodiments of the present disclosure. The method 1300 may be performed by any suitable LIDAR system, including any of the LIDAR systems described above. The method may begin at block 1302.

At block 1302, a plurality of optical signals are emitted. The plurality of optical signals may include one or more optical signal pairs, wherein each optical signal pair comprises a first optical signal and a second optical signal wherein the first optical signal and the second optical signal are counter-chirped. Each optical signal may be transmitted by a separate optical source (e.g., laser). The number of optical signal pairs may be 1, 2, 4, 8, 16, or more.

At block 1304, the optical signals are combined to form combined optical signals. The optical signals may also be amplified after being combined as described in relation to FIGS. 4A, 4B and 5A, or before being combined as described in relation to FIGS. 4C, 4D, 9 and 10. Additionally, each combined optical signal may be split between two or more optical amplifiers (SOAs) to multiply the number of the separate input signals that are distributed between the plurality of transmit/receive (TX/RX) units as described in relation to FIGS. 4A and 4B.

At block 1306, each of the combined optical signals is distributed between a plurality of transmit/receive (TX/RX) units as separate input signals to generate a plurality of outgoing optical beams. For example, each combined optical signal may be split between a plurality of TX/RX units by a 1×m splitter that splits the combined optical signal into m portions. Alternatively, each combined optical signal may be switched between a plurality of TX/RX units by a 1×m switch that switches the combined optical signal between the plurality of TX/RX units according to a scanning pattern. The distribution of the combined optical signals results in a further multiplication of the number of outgoing optical beams. In embodiments, each distributor (e.g., splitter or switch) may include any suitable the number of outputs (m=2, 8, 16, 20, 40, etc.).

At block 1308, each TX/RX unit emits a respective one of the separate input signals to generate one of the plurality of outgoing optical beams, receives light returned from a target as a return optical beam, and generates a pair of beat frequencies from the return optical beam. In some embodiments, the TX/RX units may be activated simultaneously to emit the plurality of outgoing optical beams at the same time. Alternatively, individual TX/RX units or separate groups of TX/RX units may be activated sequentially in accordance with a switching scheme related to a scanning pattern. Additionally, the output of each TX/RX unit may be switched between a plurality of TX/RX ports to further multiply the number of outgoing optical beams. In some embodiments, the plurality of outgoing optical beams cover a first dimension of a field of view of the LIDAR system. In such embodiments, the plurality of outgoing optical beams may be swept over a second dimension of the FOV of the LIDAR system using a single-axis scanning system. In some embodiments, the plurality of outgoing optical beams cover the entire FOV of the LIDAR system and a separate mirror-based scanning system can be eliminated.

At block 1310, a range and velocity of the target is determined from the beat frequency. It will be appreciated that a range and velocity can be computed for each of the outgoing optical beams that results in a return optical beam. The range and velocity may be computed by a processor such as the signal processing unit 112 (FIG. 1) shown in FIG. 1.

It will be appreciated that embodiments of the method 1300 may include additional blocks not shown in FIG. 13 and that some of the blocks shown in FIG. 13 may be omitted. Additionally, the processes associated with blocks 1302 through 1310 may be performed in a different order than what is shown in FIG. 13.

The preceding description sets forth numerous specific details such as examples of specific systems, components, methods, and so forth, to provide a thorough understanding of several examples in the present disclosure. It will be apparent to one skilled in the art, however, that at least some examples of the present disclosure may be practiced without these specific details. In other instances, well-known components or methods are not described in detail or are presented in simple block diagram form in order to avoid unnecessarily obscuring the present disclosure. Thus, the specific details set forth are merely exemplary. Particular examples may vary from these exemplary details and still be contemplated to be within the scope of the present disclosure.

Any reference throughout this specification to “one example” or “an example” means that a particular feature, structure, or characteristic described in connection with the examples are included in at least one example. Therefore, the appearances of the phrase “in one example” or “in an example” in various places throughout this specification are not necessarily all referring to the same example.

Although the operations of the methods herein are shown and described in a particular order, the order of the operations of each method may be altered so that certain operations may be performed in an inverse order or so that certain operations may be performed, at least in part, concurrently with other operations. Instructions or sub-operations of distinct operations may be performed in an intermittent or alternating manner.

The above description of illustrated implementations of the present disclosure, including what is described in the Abstract, is not intended to be exhaustive or to limit the present disclosure to the precise forms disclosed. While specific implementations of, and examples for, the present disclosure are described herein for illustrative purposes, various equivalent modifications are possible within the scope of the present disclosure, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Furthermore, the terms “first,” “second,” “third,” “fourth,” etc. as used herein are meant as labels to distinguish among different elements and may not necessarily have an ordinal meaning according to their numerical designation.

What is claimed is:

1. A light detection and ranging (LIDAR) system comprising:
a sensing system to emit a plurality of outgoing optical beams, the sensing system comprising:
a plurality of optical sources to emit a plurality of optical signals, wherein the plurality of optical signals is combined to form combined optical signals;
a transmit/receive (TX/RX) subsystem to receive the combined optical signals and distribute each combined optical signal between a plurality of TX/RX units as separate input signals, wherein each TX/RX unit is configured to emit a respective one of the separate input signals to generate one of the plurality of outgoing optical beams, receive light returned from a target as a return optical beam, and generate a beat frequency from the return optical beam; and
a signal processing system to determine a range and velocity of the target from the beat frequency generated by each of the TX/RX units.

2. The LIDAR system of claim 1, wherein the sensing system comprises:
optical amplifiers to amplify the combined optical signals and then send the combined optical signals to the TX/RX subsystem; and
a reference subsystem configured to:
combine the plurality of optical signals to form the combined optical signals; and
split each of the combined optical signals between two or more of the optical amplifiers to multiply a number of the combined optical signals received at the transmit/receive (TX/RX) subsystem.

3. The LIDAR system of claim 1, wherein the TX/RX subsystem comprises a plurality of 1×m splitters, wherein to distribute each combined optical signal between the plurality of TX/RX units, the TX/RX subsystem receives each combined optical signal at one of the plurality of 1×m splitters and splits each combined optical signal into m portions.

4. The LIDAR system of claim 1, wherein the TX/RX subsystem comprises a plurality of 1×m switches, wherein to distribute each combined optical signal between the plurality of TX/RX units, the TX/RX subsystem receives each combined optical signal at one of the plurality of 1×m switches and switches each combined optical signal between the plurality of TX/RX units according to a scanning pattern.

5. The LIDAR system of claim 1, wherein each TX/RX unit is coupled to a single dedicated TX/RX port.

6. The LIDAR system of claim 1, wherein each TX/RX unit is coupled to a plurality of TX/RX ports via a switch.

7. The LIDAR system of claim 1, further comprising a lens to spread the plurality of outgoing optical beams over a plurality of different angles.

8. The LIDAR system of claim 1, wherein the plurality outgoing optical beams cover a first dimension of a field of view of the LIDAR system, the LIDAR system further comprising a single-axis scanning system to sweep the plurality of outgoing optical beams over a second dimension of the field of view of the LIDAR system.

9. The LIDAR system of claim 1, wherein each TX/RX unit comprises a grating coupler to direct the one of the outgoing optical beams from a top surface of the TX/RX subsystem.

10. The LIDAR system of claim 1, wherein the TX/RX subsystem comprises a plurality of grating couplers arranged in a two-dimensional grid.

11. The LIDAR system of claim 1, wherein the plurality of outgoing optical beams cover a full two-dimensional field of view of the LIDAR system without sweeping the plurality of outgoing optical beams.

12. The LIDAR system of claim 1, wherein the plurality of optical signals comprises a first pair of optical signals and at least a second pair of optical signals, wherein the second pair of optical signals have a different wavelength compared to the first pair of optical signals, wherein the first pair of optical signals and the second pair of optical signals are combined to generate the combined optical signals, and wherein the LIDAR system further comprises a diffraction device to separate the first pair of optical signals and the second pair of optical signals into a pair of outgoing optical beams travelling at different angles.

13. The LIDAR system of claim 1, wherein the sensing system comprises:
a reference subsystem to generate reference signals to control a respective one of the optical sources in the plurality of optical sources;
a reference chip to process the electrical signals received from the reference subsystem; and
a pair of receiver chips to process electrical signals received from the TX/RX subsystem;
wherein the reference chip, the pair of receiver chips, the reference subsystem, and the TX/RX subsystem are mounted to a common substrate.

14. The LIDAR system of claim 13, wherein the reference subsystem and the TX/RX subsystem are formed in a single optical chip and wherein the reference chip, and the pair of receiver chips are flip chips coupled on top of the single optical chip.

15. The LIDAR system of claim 1, wherein the plurality of optical signals comprises one or more optical signal pairs, wherein each optical signal pair comprises a first optical signal and a second optical signal wherein the first optical signal and the second optical signal are counter-chirped.

16. A method of operating a frequency modulated continuous wave (FMCW) light detection and ranging (LIDAR) system comprising:
emitting a plurality of pairs of optical signals, wherein each pair of optical signals comprises a first optical signal and a second optical signal wherein the first optical signal and the second optical signal are counter-chirped;
combining each pair of optical signals to form combined optical signals;
distributing each of the combined optical signals between a plurality of transmit/receive (TX/RX) units as separate input signals to generate a plurality of outgoing optical beams;
at each TX/RX unit, emitting a respective one of the separate input signals to generate one of a plurality of outgoing optical beams, receiving light returned from a target as a return optical beam, and generating a pair of beat frequencies from the return optical beam; and
determining a range and velocity of the target from the pair of beat frequencies.

17. The method of claim 16, further comprising splitting each of the combined optical signals between two or more optical amplifiers to multiply a number of the separate input signals distributed between the plurality of transmit/receive (TX/RX) units.

18. The method of claim 16, wherein to distribute each combined optical signal between the plurality of TX/RX units comprises:
receiving each combined optical signal at one of a plurality of 1×m splitters; and
and splitting each combined optical signal into m portions.

19. The method of claim 16, wherein to distribute each combined optical signal between the plurality of TX/RX units comprises:
receiving each combined optical signal at one of a plurality of 1×m switches; and
switching each combined optical signal between the plurality of TX/RX units according to a scanning pattern.

20. The method of claim 16, wherein the plurality outgoing optical beams cover a first dimension of a field of view of the LIDAR system, the method further comprising sweeping the plurality of outgoing optical beams over a second dimension of the field of view of the LIDAR system.
